(19) United States
(12) Patent Application Publication
(10) Pub. No.: US 2009/0096656 A1
(43) Pub. Date: Apr. 16, 2009

(54) COLOR-CODING CONNECTORS FOR INFRA-RED REPEATER

(76) Inventor: Vern Smith, Corte Madera, CA (US)

Correspondence Address: LARIVIERE, GRUBMAN & PAYNE, LLP, 19 UPPER RAGSDALE DRIVE, SUITE 200, MONTEREY, CA, 93940, US

(21) Appl. No.: 11/872,856

(22) Filed: Oct. 16, 2007

(51) Int. Cl. G08C 19/12

(52) U.S. Cl. 341/176

(57) ABSTRACT

An IR controller that provides a single point for communications with a remote and connects with the various components of a video or audio system which are configured to respond to IR signals. The apparatus receives and routes IR signals either serially or in parallel to the system components through uniquely labeled or color coded IR capable cables. The apparatus may be equipped with an RF to IR converter for an RF capable remote controller.

### TECHNICAL FIELD

The present invention relates to remote control devices for electronic devices. More particularly, the present invention relates to cabling for infra-red (IR) and radio frequency (RF) remote control devices for consumer electrical devices. Still more particularly, the present invention relates to cable identification methods for remote controlled devices using IR and/or RF communication with remotely controllable consumer electronic devices.

### BACKGROUND ART

It is common in the field of consumer electronics to provide IR and RF communication links between a remote controller and an electronic device for controlling the device: applying power, removing power, adjusting parameters, etc. To accomplish this, each electronic device is assigned a unique code, either by the manufacturer or consumer, or automatically by the device, so that the device will respond only to a similarly configured remote. Such items as televisions, music systems, lighting systems, air conditioning/heating (HVAC) systems, camera systems, power control systems, door latches, motion detectors and other similar devices, are frequently configured to respond to a remote control device like, but not limited to, a cell phone. IR signals are direct, line of sight communication links, requiring a transmitter to have an unimpeded pathway to a receiver; with RF signals a direct line of sight is not required.

When a user assembles an electronic system such as a home theater, flat screen television, stereo music system, computerized network, and the like, it is not unusual to combine several electronic devices into the system, each device having its own unique IR or RF code. This results in the user facing the requirement to have either multiple remotes or a single remote with multiple code functions. As users become more inventive in assembling systems, the number of electronic devices combined into the system may increase, complicating both the interconnectivity between the components and the design of remote controls. Each device further requires a connection to an electrical power source, frequently through a power conditioning device. This further adds to the number of components and complexity of the system.

As the number of components increases, the connections between the components becomes more complicated. Further, miniaturization of the electronic devices leads to multifunction devices requiring a variety of connectors to properly integrate the system. Should one or more connections be improperly made, the system may suffer damage and will most certainly not function as desired. This requires the user to troubleshoot the system, an activity that may be quite time consuming and can lead to further damage to one or more components. What is needed is a method and apparatus to minimize or eliminate interconnectivity errors.

### DISCLOSURE OF THE INVENTION

Accordingly, the present invention is an IR or RF controller that provides a single point for communications with a remote and reliably connects with the various components of a video or audio system which are configured to respond to IR signals. The apparatus receives and routes IR signals, and connects either serially or in parallel with the system components through IR capable cables. The apparatus is preferably configured to be installed within a cabinet or otherwise out of sight within the room. Alternatively, the apparatus may be configured within a suitable containment to be a visible component of a system, much like a set-top device commonly used with televisions. In the case of an RF remote, the apparatus is equipped with an RF to IR conversion device which enhances the use by eliminating the line of sight restriction of IR links. If desired to minimize the presence of numerous components, the controller may be combined in the same containment with other devices, such as power supplies, signal conditioners, noise filters, switching controls, computers, etc.

The IR controller portion of the apparatus includes a microprocessor and provides a receiver for receiving IR commands from a remote and a transmitter for retransmitting the commands on to individual components of the user's system. The controller may retransmit IR commands either serially or in parallel, depending on the user's preference and/or individual component capabilities. In the preferred embodiment, the IR controller is placed within a cabinet behind a door or other covering, and connected via an IR cable with an IR sensor in such a way to provide a line of sight pathway for communications with a remote. Alternatively, the apparatus may be provided as a visible component of a user's system, and the IR sensor incorporated into the IR controller, the combination enclosed within a suitable housing. The IR controller can be equipped with an IR remote receiver only or an RF to IR translator, and may be equipped with both IR and RF as the controlling instrument. The RF controller portion of the apparatus, if so configured, cooperates with an RF sensor to receive RF commands from a remote, then translates the RF commands into IR for retransmission over an IR cable to the appropriate device. The controller may retransmit IR commands either serially or in parallel, depending on the user's preference and/or individual component capabilities.

A plurality of sockets, one each for each electronic device to be controlled by the IR repeater, is provided. Each connector socket is specific for each component and is identified by an identifier. The identifier may be a label and contain text, numerals, colors or symbols to identify the type of device associated with that connector socket to facilitate assembly of the system. Each connector socket may also be color coded corresponding to the color used with the identifier, in which case the identifier may be modified if desired. Each connector socket is configured to accept a standard connector plug for an IR cable to connect an electronic device to the IR Repeater.

The connectivity portion of the apparatus provides user-friendly cabling that significantly reduces the probability of connection errors. This is accomplished by IR capable cables having at least one end that is uniquely color coded and/or labeled as to the type of device with which they are intended to be used: video device, audio device, computer, recorder, etc. Each IR cable is color coded on one or both ends to correspond to each of the connector sockets. Color coding of each IR cable with a unique color facilitates connecting each electronic device with the appropriate connector socket. The IR controller portion corresponding IR connection points are similarly color coded and identified. Alternatively, each controller connection point may be physically uniquely formed to be connectable only with a cable which is similarly physically formed. The IR cables are preferably single conductors but may be bundled into multiconductor cables for convenience in some applications. When multi conductor cables are used, the emitter end is also labeled, marked or colored. For example, if a connector and socket were green and the cable had three emitters, one emitter could have one green band, the second emitter would have two green bands and the third emitter would have three green bands. In summary, the present invention uniquely provides the capability for quicker and more correctly reliable set up of control sets and controlled devices.

### BRIEF DESCRIPTION OF THE DRAWING

For a better understanding of the present invention, reference is made to the below referenced accompanying Drawing. Reference numbers refer to the same or equivalent parts of the present invention throughout the several figures of the Drawing.

FIG. 1 is a diagrammatic illustration of the system of the present invention.

FIG. 2 is an illustration of an exemplary connector panel of the present invention.

### MODES FOR CARRYING OUT THE INVENTION

The present invention is a IR or RF controller (repeater 10) that provides a single point for line of sight communications with an IR remote 5 and reliably connects with the various electronic devices (20, 21, 22) of a video or audio system which are configured to respond to IR signals. The apparatus receives and routes IR signals and connects with the system components through IR capable cables. The IR repeater 10 cooperates with an internal IR sensor 12 or remote receiver 13 for receiving IR commands from a remote 5 and retransmits the commands on to individual components of the user's system. The microprocessor preferably is capable of functions such as, but not limited to, setting up control sets and control devices attached to the repeater; setting up control sets for devices within the system; networking of portable computer or the handheld remote set up of devices in the system; transcoding RF to IR device specific codes sets; using generic remotes with generic control code sets; transcoding generic code sets to device specific control code sets; and wideband IR repeating, such as z-wave and the like.

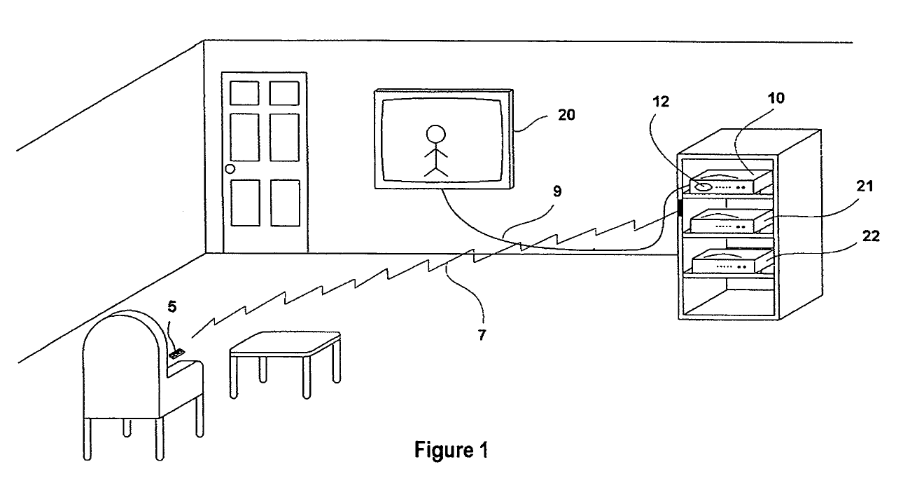

Referring to FIG. 1, the exemplary components of the present invention are illustrated. IR repeater 10 may be housed in a single case, suitable for open display within a user's room; the case further containing IR sensor 12. Alternatively, IR repeater 10 may be physically separated from IR remote receiver 13 and connected therewith via an IR cable (not shown). Remote 5 is used by an operator to send control commands over IR link 7 to IR sensor 12 or remote receiver 13. In the case of an RE remote 5, IR link 7 would be an RF link and IR repeater 10 would be equipped with an RF to IR conversion capability which enhances the system flexibility by eliminating the IR line of sight restriction between IR remote 5 and sensor 12. An RF configured apparatus may be enclosed in a cabinet, leaving no visible components.

IR repeater 10 receives control commands from IR sensor 12 or remote receiver 13 and retransmits the command over IR cables to the desired electronic device 20, 21, or 22. Electronic devices 20, 21, 22 may be any number of electronic devices such as audio or visual devices, computational devices, and the like. For example, first device 20, represented here for illustration only and not intended to be limiting, may be a television and is connected with IR repeater 10 via IR cable 9.

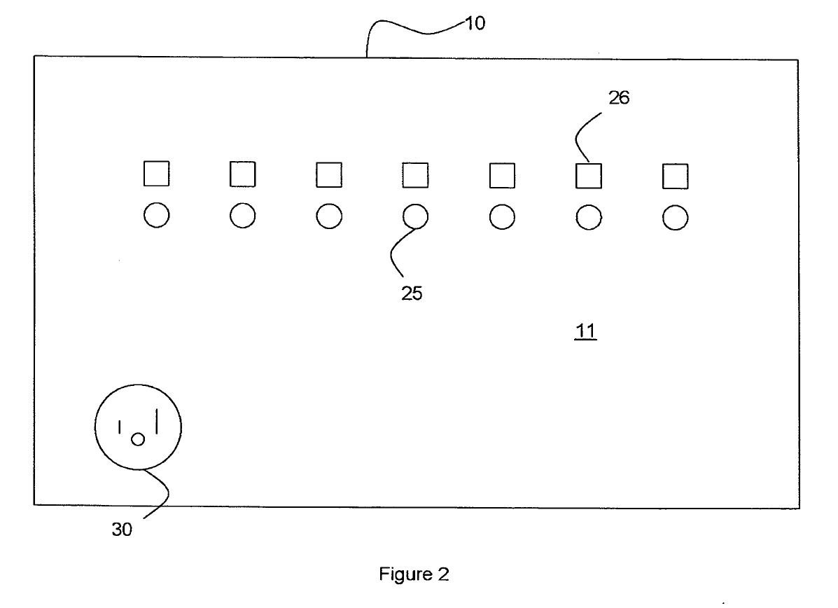

Referring to FIG. 2, an illustration of an exemplary connector panel 11 of the IR Repeater 10 is shown. Connector panel 11 is preferably located on the back of IR repeater 10, but may alternatively be located on a side, top or the front if desired. Power connection 30 is preferably a socket for receiving a standard alternating current (AC) power cord for powering IR repeater 10, but alternatively may be a hard wired conventional power cord.

Connector socket 25 represents a plurality of sockets, one each for each electronic device to be controlled by IR repeater 10 and one for IR sensor 12. Each connector socket 25 is specific for each component and is identified by an individual identifier 26. Identifier 26 may be uniquely colored, a label containing text, numerals or symbols, or any combination thereof, to identify the type of device associated with that connector socket to facilitate assembly of the system. Each connector socket 25 is configured to accept a standard connector plug for an IR cable 9 to connect electronic devices with IR Repeater 10.

In the exemplary embodiment of the invention, each IR cable 9 is uniquely colored with the same color used on connector sockets 25, so that, for example, a red colored cable would plug into a red colored socket which is identified by its label as for a specific type of peripheral device. The user would then know that the opposite end of the cable would be correctly connected with that particular type of device. The colors may be incorporated at one or both ends of the cable, or within the exterior covering of the cable, or in any combination. IR cables 9 are preferably single conductors but may be bundled into multiconductor cables for convenience in some applications. Each conductor of such a bundle would be, at a minimum, color coded to identify specific receptacles to which the conductor should be connected. When multi conductor cables are used, the emitter end is also labeled, marked or colored. For example, and not intended to be limiting, if a connector and socket were green and the cable had three emitters, one emitter could have one green band, the second emitter would have two green bands and the third emitter would have three green bands. Alternatively, the color coding of sockets 25 could be eliminated, in which case the user would know from the socket label that whatever color cable was selected was to be connected only to the type of device indicated by the connector label.

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.”

All structural and functional equivalents to the elements of the above-described preferred embodiment and additional embodiments that are known to those of ordinary skill in the art are hereby expressly incorporated by reference and are intended to be encompassed by the present claims. However, it should be readily apparent to those of ordinary skill in the art that various changes and modifications in form, apparatus material, and fabrication material detail may be made without departing from the spirit and scope of the invention as set forth in the appended claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. No claim herein is to be construed under the provisions of 35 U.S.C. 112, sixth paragraph, unless the element is expressly recited using the phrase “means for.”

### INDUSTRIAL APPLICABILITY

The present invention applies industrially to electronic device control networks. More particularly, the present invention applies to remotely controlled electronic device control networks. The present invention may be assembled by a knowledgeable practitioner using readily available components.

What is claimed:

1. A remote control apparatus for an electronic system having remotely controllable electronic devices, comprising:
a remote control for generating commands;
a sensor for receiving commands from the remote;
a repeater for receiving commands from the sensor and retransmitting the commands over IR cables; and
IR cables having unique identifiers for connecting the repeater with the electronic devices.

2. The apparatus of claim 1 wherein the repeater incorporates a microprocessor programmed to perform one or more functions selected from the group of functions comprising: setting up control sets and control devices attached to the repeater; setting up control sets for devices within the system; networking of portable computer or the handheld remote set up of devices in the system; transcoding RF to IR device specific codes sets; using generic remotes with generic control code sets; transcoding generic code sets to device specific control code sets; and wideband IR repeating.

3. The apparatus of claim 1 wherein the repeater has a plurality of sockets for connecting with the IR cables, each socket having a unique identifier label.

4. The apparatus of claim 3 wherein the cables further have unique identifiers selected from the group of identifiers comprising colors, text, numerals and symbols.

5. The apparatus of claim 4 wherein the location of the identifiers are selected from one or more of the group of locations comprising one end, both ends, and within the external covering of the cable.

6. The apparatus of claim 1 wherein the repeater has a plurality of sockets for connecting with the IR cables, each socket having a unique identifier label selected from the group of labels comprising colors, text, numerals and symbols, and the cables have on at least one end unique labels selected from the group of labels comprising colors, text, numerals and symbols.

7. The apparatus of claim 6 wherein the cables further have on both ends unique labels selected from the group of labels comprising colors, text, numerals and symbols.

8. A remote control apparatus for an electronic system having remotely controllable electronic devices, comprising:
a remote control for generating commands;
a sensor for receiving commands from the remote, wherein the remote control device communicates with the sensor over a link selected from the group comprising an IR link and an RF link;
a repeater for receiving commands from the sensor and retransmitting the commands over IR cables; and
IR cables having unique identifiers for connecting the repeater with the electronic devices.

9. The apparatus of claim 8 wherein the cables further have on the at least one end unique labels selected from the group of labels comprising color, text, numerals and symbols.

10. The apparatus of claim 9 wherein the repeater has a plurality of sockets for connecting with the IR cables, each socket having a unique identifier label selected from the group of labels comprising color, text, numerals and symbols, and the cables have on at least one end unique labels selected from the group of labels comprising color text, numerals and symbols.

11. The apparatus of claim 8 wherein the repeater has a plurality of sockets for connecting with the IR cables, each socket having a unique identifier label selected from the group of labels comprising color, text, numerals and symbols, and the cables have on at least one end unique labels selected from the group of labels comprising color, text, numerals and symbols.

12. A remote control apparatus for an electronic system having remotely controllable electronic devices, comprising:
a remote control for generating commands;
a sensor for receiving commands from the remote;
a repeater for receiving commands from the sensor and retransmitting the commands over IR cables, the repeater having a plurality of sockets for connecting with the IR cables, each socket having a unique identifier label; and
IR cables having unique identifiers for connecting the repeater with the electronic devices, the identifiers selected from the group of identifiers comprising colors, text, numerals and symbols.
